(19) United States
(12) Patent Application Publication
(10) Pub. No.: US 2026/0033453 A1
(43) Pub. Date: Feb. 5, 2026

(54) VERTICAL REFRIGERATED PET FEEDER SYSTEM

(71) Applicant: Happy Llama LLC dba Happy Llama Tech, Silver Spring, MD (US)

(72) Inventors: Ahmad Seyfi, Silver Spring, MD (US); Leslie Bakeer, Silver Spring, MD (US)

(21) Appl. No.: 19/282,287

(22) Filed: Jul. 28, 2025

Related U.S. Application Data
(60) Provisional application No. 63/677,841, filed on Jul. 31, 2024.

(51) Int. Cl. A01K 5/02; G06V 40/10

(52) U.S. Cl. CPC A01K 5/0291; A01K 5/0266; G06V 40/10

(57) ABSTRACT

A pet food feeding system that can include a series of stacked trays containing food, or other comestible elements, that can be stored within a refrigerated container, where within the container, there can be a set of motors configured to manipulate the trays for dispensing through a dispensing port. The system can include a controller that may monitor the time a tray remains dispensed, whether the comestible elements were consumed or partially consumed, and retain and/or redispense an unconsumed portion of the comestible elements. The controller can further determine the approach of a pet to signal the dispensing.

### BACKGROUND

Automated pet feeders are widely used to deliver scheduled feedings, particularly when the owner is away. Most commercial feeders are designed for dry food and rely on gravity-fed or timed-release mechanisms. These systems are generally suitable for kibble but do not meet the needs of pets fed with wet, raw, or other perishable foods that require refrigeration.

While some refrigerated feeders have been introduced, they typically expose food to ambient air once dispensed and do not support re-cooling if the food goes uneaten. This leads to food waste and limits feeding flexibility—especially for pets that graze or cat at irregular intervals.

Many existing designs also use a rotating disc mechanism, which presents several limitations. Rotational platforms increase device footprint when accommodating wide, shallow bowls preferred by some pet owners. They also restrict individual tray-level control and re-delivery, and expose adjacent trays to warm air during operation, reducing thermal efficiency.

A prior patent application U.S. Ser. No. 18/381,958, filed Oct. 19, 2023, by the inventors disclosed a refrigerated rotating-tray design. The present disclosure attempts to improve on that concept.

### SUMMARY

This disclosure relates to a refrigerated pet food feeding system that can comprise a refrigeration system; an insulated enclosure that can have a front-loading access door and a dispensing port disposed thereon, where a dispensing door can be located on the dispensing port; it may further include a plurality of food trays that may be arranged vertically within the insulated enclosure, wherein each food tray can be structured and configured to store a portion of food. Such a refrigerated pet food feeding system can also include a motorized lift mechanism that may be structured and configured to align a selected tray of the plurality of food trays with the dispensing port, it may also include a horizontal transfer mechanism that can be configured to move the selected tray within the insulated enclosure to a dispensing position outside the insulated enclosure via the dispensing port, and it can also retract the selected tray after a predetermined period, wherein the dispensing door can be configured to open and close in coordination with the movement of the selected tray, and a controller configured to operate the motorized lift mechanism, the lateral transfer mechanism, and the door in accordance with a programmed feeding schedule.

An alternative embodiment of the above refrigerated pet food feeding system can further have a motorized lift mechanism that can be at least one of a group consisting of a vertical lift motor, at least one belt drive, or a vertical ball screw.

In a variation of the above system, the motorized lift mechanism may further comprise a motorized shuttle to retrieve and deliver the selected tray.

In an alternative to the first embodiment, the horizontal transfer mechanism may also comprise a horizontal ball screw, a horizontal motion motor, a horizontal guide rail, and a horizontal carriage.

In an alternative to the first embodiment, a heating element may be positioned beneath the selected tray in the dispensing position outside the insulated enclosure.

In another alternative to the first embodiment, wherein after the predetermined time, the controller can be configured to deliver a previously selected tray, wherein the previously selected tray may still contain an unconsumed portion of food, for a second predetermined period to the dispensing position outside the insulated enclosure via the dispensing port.

In another alternative to the first embodiment, the embodiment may further comprise a remote camera system that can be configured to visually identify a pet, and upon identification of the pet, it may also then wirelessly communicate an authorization signal to the controller to move the selected tray to the dispensing position.

In a variation of the above system, the refrigerated food feeding system can also include a camera system that can be cloud-connected and may perform pet identification remotely before communicating the authorization signal. Or, in another variation of the above system, the refrigerated food feeding system may have a remote camera system that can be mounted separately from the feeding system and positioned to capture the approaching pet from an alternate angle. Or, in a further variation of the above system, the refrigerated food feeding system may also be configured so that the controller can be configured to associate the identified pet with a unique feeding profile.

In another alternative to the first embodiment, the refrigerated food feeding system may include at least one additional refrigerated food feeding system that can be linked via a network to the refrigerated food feeding system. Or, the refrigerated food feeding system may include a food presence sensor that can be set up to detect remaining food in the dispensed tray after the predetermined time. In a variation of the previous embodiment, the refrigerated food feeding system may also have a controller that can be configured to track the amount of remaining food, and further wherein the controller may then communicate to a user device the presence of the remaining food.

In another embodiment of a refrigerated food feeding system can be a networked multi-unit refrigerated food feeding system that can comprise at least one of the refrigerated food feeding system of the first embodiment, where that refrigerated food feeding system can act as a coordinator system feeder, which may have at least one subordinate food feeding system that can be linked to the coordinator system feeder, where the at least one subordinate food feeding may be able to receive at least one of a control signal or scheduling data, where the at least one subordinate food feeding system can comprise an insulated enclosure that may have a front-loading access door and a dispensing port disposed thereon, wherein a dispensing door can be disposed on the dispensing port. This embodiment may also include a plurality of food trays that can be arranged vertically within the insulated enclosure, where each food tray can be set up to store a portion of food, where a motorized lift mechanism can be structured and configured to align a selected tray of the plurality of food trays with the dispensing port, and where a horizontal transfer mechanism can be structured and configured to move the selected tray within the insulated enclosure to a dispensing position outside the insulated enclosure via the dispensing port, and may then also be able to retract the selected tray after a predetermined period, where the dispensing door can be configured to open and close in coordination with the movement of the selected tray; and where a controller can be configured to operate the motorized lift mechanism, the lateral transfer mechanism, and the door in accordance with a programmed feeding schedule.

In another alternative to the previous embodiment, the refrigerated food feeding system can be set up to have a motorized lift mechanism that can be at least one of a vertical lift motor, at least one belt drive, or a vertical ball screw.

In another alternative to the previous embodiment, the refrigerated food feeding system can have a motorized lift mechanism that may further comprise a motorized shuttle to retrieve and deliver the selected tray.

In another alternative to the previous embodiment, the refrigerated food feeding system can also be set up where the horizontal transfer mechanism can comprise a horizontal ball screw, a horizontal motion motor, a horizontal guide rail, and a horizontal carriage. Or, the refrigerated food feeding system can further include a heating element that can be positioned beneath the selected tray in the dispensing position outside the insulated enclosure. Or, the refrigerated food feeding system may further comprise a remote camera system that can be configured to visually identify a pet and, upon identification of the pet, may also be able to wirelessly communicate an authorization signal to the controller to move the selected tray to the dispensing position. In another alternative to the previous embodiment, the refrigerated food feeding system's camera system can be cloud-connected and may also perform pet identification remotely before communicating the authorization signal.

The above summary is not intended to describe each and every example or every implementation of the disclosure. The description that follows more particularly exemplifies various illustrative embodiments.

### BRIEF DESCRIPTION OF DRAWINGS

FIG. 1A is a front perspective view of an embodiment of an automated pet feeder system;

FIG. 1B is a rear perspective view thereof;

FIG. 2 is a left side view thereof;

FIG. 3 is a left side perspective cutaway view thereof.

FIG. 4A is a left side of an automated pet feeder system, illustrating a first sequence of a dispensing sequence;

FIG. 4B is a left side view thereof, illustrating a second sequence of a dispensing sequence;

FIG. 4C is a left side view thereof, illustrating a third sequence of a dispensing sequence.

FIG. 5 is a partial view of an automated pet feeder system's tray gripper arm structure.

FIG. 6A is a top view of an embodiment of an automated pet feeder system;

FIG. 6B is a side view thereof.

FIG. 7A is a front perspective view of another embodiment of an automated pet feeder system;

FIG. 7B is a rear perspective view thereof;

FIG. 8 is a front cutaway view thereof, illustrating the interior;

FIG. 9 is a side cutaway view thereof, illustrating the interior;

FIG. 10 is a side cutaway view thereof, illustrating the interior in a dispensing position.

FIG. 11 is an overview of an embodiment of an automated pet feeder system with a remotely placed camera.

FIG. 12 is an overview of an embodiment of an automated pet feeder system having a multitude of networked feeders.

### DETAILED DESCRIPTION

The present disclosure relates to automated pet feeders that can include re-deliverable tray systems. Various embodiments of the automated pet feeder will be described in detail with reference to the drawings, wherein like reference numerals represent like parts and assemblies throughout the several views. Reference to various embodiments does not limit the scope of the automated pet feeder system disclosed herein. Additionally, any examples set forth in this description are not intended to be limiting and merely set forth some of the many possible embodiments for the automated pet feeders. It is understood that various omissions and substitutions of equivalents are contemplated as circumstances may suggest or render expedient, but these are intended to cover applications or embodiments without departing from the spirit or scope of the disclosure. Also, it is to be understood that the phraseology and terminology used herein are for the purpose of description and should not be regarded as limiting.

The present invention relates to an automated pet feeder capable of storing, cooling, delivering, and re-refrigerating multiple portions of perishable pet food. Unlike existing feeders that either expose food to ambient conditions or cannot re-store uneaten portions, this system maintains all trays at refrigerated temperatures before and after presentation.

The present invention expands on that concept with a more flexible architecture, using a vertically stacked tray system within a cooled enclosure. Trays are individually selected by vertical alignment and horizontal movement, enabling precise control individually, support for various tray sizes, and improved thermal isolation.

This new system can support:
Storage and re-storage of perishable food trays,
Wide, shallow, or custom bowl dimensions while maintaining a compact footprint,
Smart scheduling with optional re-delivery, and
Improved hygiene and energy efficiency via isolated tray access.

While primarily intended for pets, the invention also applies to other time-based refrigerated dispensing scenarios. Potential use cases include veterinary medication, livestock or wildlife feeders, temperature-sensitive food or supplement delivery, and lab automation where scheduled access to cooled items is needed. For larger or industrial applications, compressor-based cooling and scaled-up trays may be used.

At its core, the device can use a vertically stacked arrangement of food trays housed within a thermally insulated, refrigerated enclosure. When it is time to feed, a selected tray can be first moved vertically to align with a dispensing port, and then moved horizontally to extend partially or fully outside the enclosure, allowing the pet access. After a configurable time interval, the tray can be automatically retracted back into the cooled interior to preserve any uneaten food. This process may repeat multiple times.

Multiple mechanical configurations are supported, including embodiments where either the tray stack or the retrieval mechanism moves vertically. Horizontal motion can be achieved via motorized arms, shuttle assemblies, or equivalent mechanisms, depending on the configuration. All configurations can follow the same basic principle: selective retrieval and re-storage of food trays while maintaining thermal control.

The feeder may incorporate thermoelectric or compressor-based refrigeration. Optional heating elements may warm food just prior to delivery, either inside the enclosure or at the point of dispensing. Trays can be removable, may be dishwasher-safe, and can be presented through a motorized or spring-loaded access door with thermal sealing. Additional hygiene features may include odor filters, UV-C sterilization, and app-controlled cleaning reminders.

Integrated sensors may be used for multiple measurement functions. For example, weight sensors (scales) positioned beneath the food tray can quantify the amount of food delivered and track how much remains after feeding, enabling portion verification, consumption tracking, and dietary trend analysis. Another example can include a separate scale platform or low-profile pad located in front of the tray, which may measure the pet's body weight during feeding, supporting passive health monitoring and early detection of weight fluctuations.

In addition to physical scales, other sensing technologies may be used to estimate the volume or mass of food served or consumed, i.e., a computer vision system, including RGB cameras paired with AI models, may assess portion size by analyzing tray contents before and after feeding. Or, a 3D sensor, such as a time-of-flight (ToF) or structured light sensor, can generate volumetric data to estimate food mass non-invasively

Additional sensors that may be included, are infrared or ultrasonic distance sensors which may measure the height or volume of food in open trays. Multi-sensor fusion techniques may combine vision, weight, and depth data to improve accuracy and detect anomalies like food spillage or pet interference.

These sensing systems can operate locally or upload data for cloud-based processing and long-term trend analysis, contributing to personalized feeding recommendations and wellness monitoring. Sensors detect tray position, lid state, and feed events. Power backup systems preserve user preferences and schedule logic. Feeding schedules, alerts, and status can be managed via a mobile application. In some embodiments, a camera with computer vision may be positioned to recognize pets and authorize feeding based on identity, either locally or through a connected cloud system. This may include unique feeding profiles for the individually identified pets.

In one embodiment, the feeder may include a vertically oriented, insulated enclosure that can house a stack of food trays. The enclosure may incorporate a refrigeration system, which can be thermoelectric, compressor-based, or another suitable cooling method, and may be capable of maintaining internal temperatures appropriate for storing wet or raw pet food.

The food trays can be arranged in a vertical stack, with each tray optionally sized to hold a single portion of food. Trays may be constructed from food-grade plastic, stainless steel, or other suitable materials, and can be removable to facilitate cleaning. In certain versions, optional tray inserts may be provided to support varied diets, portion sizes, or feeding schedules.

Depending on the configuration, food trays may take the form of circular, rectangular, wedge-shaped, or custom-contoured geometries. The choice of tray shape can vary based on spatial design considerations, desired cooling performance, or alignment requirements with internal lift and dispensing components. These tray variations are intended to remain compatible with the vertical lift and lateral dispensing mechanisms described herein.

To maintain consistent vertical spacing and prevent shifting during operation, each tray may include alignment features. These may take the form of interlocking pegs, notches, ridges, or slots that engage with adjacent trays or the tray stack frame. Trays may rest on integrated rails or guide structures within the enclosure that interface with these alignment features. This configuration supports smooth vertical movement, minimizes mechanical misalignment, and preserves airflow and thermal consistency between trays.

### Tray Movement Mechanism

To deliver food, the device includes a motorized mechanism that vertically aligns a selected tray with a front-facing dispensing port. Two main configurations are contemplated:

In one configuration, a motorized lift mechanism moves the entire tray stack vertically, positioning the desired tray at the fixed dispensing height.

In an alternate configuration, a tray shuttle mechanism moves independently within the enclosure, traveling vertically to retrieve a specific tray and then delivering it laterally toward the dispensing port.

Tray movement may be guided via rails, slots, or tracked channels and may use drive systems such as belt drives, lead screws, or other actuators as further described infra.

After vertical alignment, a lateral transfer mechanism moves the tray outward. This mechanism may consist of a pusher arm, servo-actuated rail, or a gravity-assisted guide. After a preset time, the tray may be retracted back into the refrigerated compartment, preserving uneaten food for future delivery.

The device may incorporate one or more position sensors to detect vertical alignment and tray height, such as optical interrupters, magnetic encoders, or hall effect sensors. Additional limit switches or contact sensors may confirm full extension and retraction of the tray carriage during feeding. In the event of power loss, a backup homing routine may be initiated on restart, using default motor positions, mechanical end stops, or redundant sensors to re-establish the system's spatial reference. Torque sensing or encoder feedback may be used by the controller to detect motor stalls, obstructions, or other tray motion faults.

### Door and Insulation Features

The dispensing port is covered by a movable door that seals the enclosure when not in use. The door may swing open, drop down, or slide laterally, and is actuated in coordination with tray delivery. A gasket or thermal seal around the door maintains insulation during rest periods.

To prevent contamination, the door may include a lip or overhang to reduce ingress of external debris or pet saliva. In some embodiments, the door is designed to be easily detached for cleaning.

In various embodiments, the dispensing port may be sealed by a movable door, which can include drop-down, sliding, or swinging mechanisms. The door may be actuated by a motor, spring, or other suitable drive system, depending on the configuration.

### Temperature Control

The refrigeration system may use a thermoelectric module connected to aluminum heat spreaders positioned around or between trays. A fan may assist in internal air circulation. In another embodiment, a compressor-based system provides greater cooling capacity and improved thermal retention during power outages.

Optionally, a heating element may be located under the delivery area to gently warm food before serving. This component activates only after the tray has exited the refrigerated compartment and operates independently, ensuring that internal tray temperatures remain unaffected.

### Hygiene and Cleaning Features

Trays are easily removable for cleaning and may be dishwasher-safe. The interior of the device features smooth surfaces and accessible components to facilitate wiping and sanitation.

The system may include: a UV-C LED module for sterilizing trays or internal walls, replaceable odor-neutralizing filters or carbon pads, a mobile app feature that allows users to set reminders for cleaning or replacing filters, and/or a “cleaning mode” that automatically positions trays for easy access.

### Power and Backup Systems

To maintain functionality during power interruptions, the device may include a battery backup system. The battery supports logic control, tray movement, and door actuation for a limited number of feeding cycles.

The refrigeration system, particularly in a compressor-based configuration, can retain cold temperatures for extended periods due to insulation and thermal mass. Manual override options may include a mechanical release, backup latch, or removable panel to retrieve food during a complete power loss. And, feeding schedules and tray status are stored in non-volatile memory or backed by a small clock battery to ensure settings are retained through power interruptions. The mobile app may notify users of a detected power loss.

### Smart Features and Connectivity

Feeding schedules can be programmed via a mobile app. The app may also allow users to: enable or disable sound alerts, receive tray status notifications, customize feeding intervals, and/or set cleaning and maintenance reminders. In some embodiments, the device may use facial recognition via a built-in camera to identify individual pets and offer personalized feeding plans.

### Remote Visual Identification

In some embodiments, the pet identification system is not integrated directly into the feeder, but instead operates as a separate camera module that communicates with the device via Wi-Fi or Bluetooth.

### Distributed Multi-Feeder System and Shared Cooling Infrastructure

In some embodiments, the system can comprise a distributed architecture in which a primary (or “coordinator”) feeder device manages scheduling, pet identification, and feeding logic for itself and one or more secondary (satellite) feeder units.

The coordinator device can include a full refrigeration system, control processor, and network communication interface (e.g., Wi-Fi, Bluetooth, or cellular). The secondary units may include only partial hardware, such as motorized tray systems or dispensing mechanisms, and may omit refrigeration, sensors, or connectivity features to reduce cost.

These secondary units may connect to the coordinator either wirelessly (for data only) or via a wired connection (for data and/or power). In one configuration, the coordinator can relay feeding instructions from a mobile application to nearby secondary units, allowing users to control multiple feeders from a single app interface even if some units lack direct internet access.

In some embodiments, the secondary units can be designed to be physically stacked on or adjacent to the coordinator. This configuration may allow the satellite units to share insulation, benefit from thermal gradients, or draw power and cooling support from the coordinator. Such modular arrangements can enable scalable, compact multi-pet installations that maintain smart functionality while minimizing footprint and hardware redundancy.

This architecture can support flexible system expansion and lower overall cost, making it suitable for homes with multiple pets, shelters, or veterinary environments. Other modular expansion concepts are further described infra.

### Alternative Motion and Tray Handling Mechanisms

The vertical and horizontal motion systems described in the primary embodiments may be implemented using a variety of mechanical components beyond those explicitly shown in the figures. Alternative vertical motion systems can include: timing belts with pulleys, rack and pinion gear assemblies, scissor-lift mechanisms, telescoping linear actuators, and/or pneumatic or hydraulic lift systems. While alternative horizontal motion systems can include: cable-and-pulley systems, lead screw actuators, cam-following shuttle tracks, and/or magnetic linear drives. These alternatives may provide benefits in terms of cost, reliability, footprint, or manufacturability and should be considered within the scope of the invention.

### Tray Variations and Feeding Container Formats

Trays may include a variety of alternative container types and formats depending on application with the following elements: shallow, wide bowls for cats or small dogs, lidded or sealed containers for preserving freshness, flexible food-safe pouches held in shaped cradles, single-use or disposable tray inserts, multi-compartment trays for separating food types, and/or vacuum-sealed tray assemblies. Tray shapes and materials may vary, provided they are compatible with the retrieval and dispensing system.

### Sensor Options and Event Detection

In addition to tray position and lid state sensors, the system may optionally include: weight sensors for detecting uneaten food, infrared proximity sensors to detect pet presence, magnetic or Hall-effect sensors for tray alignment, NFC/RFID readers for pet collar identification, and/or environmental sensors to monitor ambient temperature or humidity. These sensors can enable advanced logic for feeding confirmation, hygiene control, and data logging.

### Alternate Dispensing Mechanisms

While the main embodiment involves horizontal translation of a tray to a presentation position, the invention may alternatively use: pivoting tray arms to swing trays outward, tilting platforms that present trays at an angle, gravity-drop chutes for single-use containers, and/or rotating or scissor mechanisms to extend trays. These variants may offer trade-offs in mechanical complexity or space usage but remain within the intended scope.

### Modular and Passive Cooling Variants

In some embodiments, the refrigerated chamber may support: removable PCM cartridges for passive cooling, modular cooling blocks that attach to satellite units, insulated interchangeable tray modules with embedded cooling, and/or detachable cooling pods rechargeable in external base stations. These configurations enable use in off-grid, travel, or cost-sensitive deployments where power is intermittent or unavailable.

### Food Waste Detection and Adaptive Feeding

In some embodiments, the feeder includes one or more sensors to detect whether food has been consumed. The sensors that may be included in such embodiments can be: optical sensors, infrared proximity sensors, capacitive load cells, and/or image-based systems capable of detecting food presence and quantity. The system may record the outcome of each feeding event and determine whether food was fully or partially eaten; in response, the device may: send notifications to the user, trigger re-delivery logic, or adapt future scheduling (e.g., reducing portion size or skipping the next meal). Logged data may be displayed through a companion app to provide insights into pet behavior, dietary habits, and potential health concerns.

### Temperature and Environmental Monitoring

In some embodiments, the device can include environmental sensors to monitor: internal compartment temperature, tray-specific temperature, ambient external temperature, and/or internal humidity. These measurements may be used to dynamically adjust the refrigeration cycle, trigger fan-assisted airflow, or alert the user in the event of a malfunction or food safety risk.

The controller may compare live sensor readings to predefined thresholds and log temperature trends over time. Alerts may be generated if refrigeration is interrupted, ambient conditions become excessive, or moisture buildup is detected that could impact food quality. These features support compliance with food safety guidelines and offer users peace of mind when storing perishable pet food.

### Modular Expansion and Tray Subsystems

In some embodiments, the system is modular and allows the user to expand capacity by adding additional tray modules. These modules may be designed to stack vertically or connect laterally to the primary enclosure. Each module may include: its own passive or active cooling system, onboard sensors (e.g., for temperature or tray presence), and/or interfaces with the main controller via physical connectors or wireless communication. Modular expansion may enable the device to scale to household needs, by: supporting more pets, allowing longer periods between feedings, and/or accommodating diverse dietary regimens.

In some configurations, the modules may be detachable tray banks that are pre-loaded, refrigerated separately, and swapped into the main unit as needed. The controller or mobile application may detect connected modules automatically and adjust feeding logic to accommodate additional trays.

### Alternate Applications and Delivery Mechanisms

While primarily designed for feeding pets, the invention may also be used to store and dispense other perishable items requiring scheduled delivery and cold storage. For example, refrigerated medications or supplements where trays may be loaded with veterinary treatments or medical items, with access scheduled and usage logged. The invention may also be used to store and dispense other perishable items requiring scheduled delivery and cold storage for robotic delivery, where the feeder may interface with a mobile robotic platform that transports trays to different rooms, kennels, or enclosures. The robot may dock with the device, receive a tray, and navigate autonomously or semi-autonomously. Communication between the feeder and robot may be handled via local wireless protocols or cloud infrastructure.

This makes the system suitable for shelters, clinics, or multi-pet homes requiring centralized refrigerated storage and distributed delivery.

### Automated Cleaning and Expiration Management

In some embodiments, the system includes automated maintenance features to preserve hygiene and reduce user burden. These may include: tray sanitization modes having integrated steam jets, disinfectant mist sprays, or UV-C light exposure, a freshness tracking timers which can monitor how long food has been in each tray and alert the user if expiration is likely, and/or a filter management system including tracks cumulative runtime of air circulation or odor filtering systems and recommends replacement. Maintenance reminders may appear in the mobile app. The controller may also support override or snooze options to delay non-critical alerts.

### Alternate Cooling Technologies and Thermal Backup

In some embodiments, the refrigeration system may use a miniature vapor-compression module instead of a thermoelectric (Peltier) system or standard compressor. Miniature vapor-compression systems offer improved cooling capacity and energy efficiency in a compact form factor, making them well-suited for long-term refrigerated storage in consumer or veterinary applications. These systems may operate with reduced noise levels and deliver faster temperature recovery after food access events.

To improve thermal retention and reliability during power interruptions, the device may incorporate phase change materials (PCMs) within the enclosure walls or around the tray stack. PCMs absorb and release thermal energy at a predefined transition temperature, helping to stabilize internal temperatures without active cooling. This passive thermal regulation reduces refrigeration duty cycles during normal operation and preserves food safety in the event of power loss. These cooling enhancements may be used individually or in combination with each other and with existing insulation or active cooling technologies.

### Software-Only Scheduling and Virtual Integration

In some embodiments, the invention may be partially implemented as a software platform that controls third-party or OEM hardware feeders through an API or integration layer. The software may synchronize feeding schedules, sensor events, or food delivery confirmation across multiple brands or device types.

This enables the invention's core scheduling, re-storage, and hygiene logic to be extended to a broader ecosystem of connected feeding hardware, even when the underlying devices use differing motion, tray, or cooling mechanisms. Cloud-based updates and AI-driven behavior analysis may refine feeding routines over time based on pet habits and consumption trends. This abstraction layer enables licensing of core logic while allowing hardware diversity.

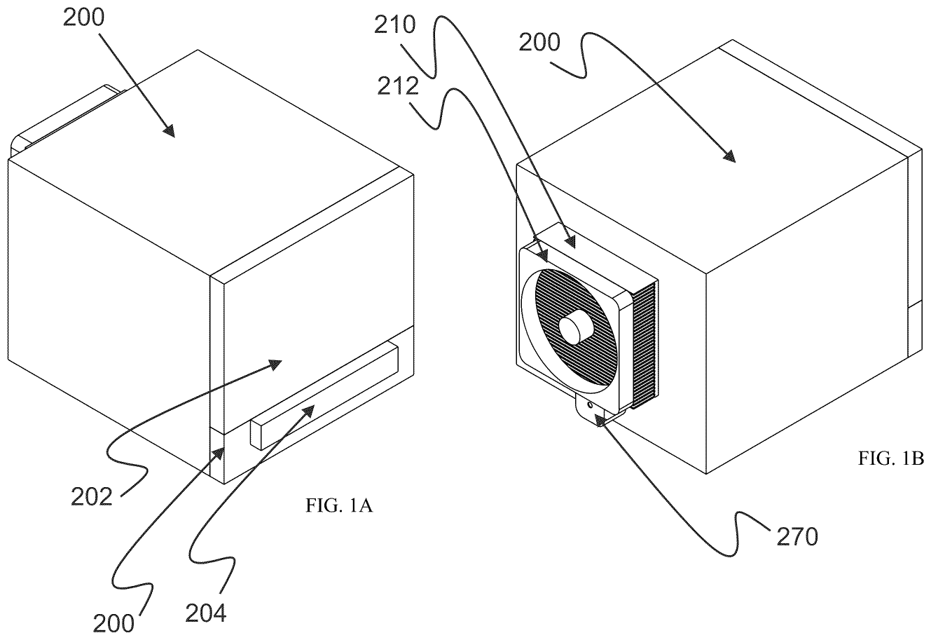

FIGS. 1A-B shows two perspective views of an embodiment of a refrigerated pet food feeding system. FIGS. 1A & B shows two perspective views (front-right-top and back-right-top) of an alternate feeder embodiment, highlighting the insulated enclosure, access doors, cooling components, and horizontal motion motor.

The left side of the figure presents a front-right-top view. The feeder can be enclosed in an insulated outer casing (200), which can include a front-loading access door (202) for placing trays inside the chamber, and a smaller dispensing door (204) located below the access door for presenting food to the pet. Both doors (202, 204) can be insulated to preserve internal temperature.

The right side shows a back-right-top view of the same feeder. The same insulated enclosure (200) and the side profile of the access door (202) are visible. A heatsink (210) and heatsink-mounted fan (212) can be attached to the back panel of the device to provide active cooling. A horizontal motion motor (270), mounted toward the rear, is also shown and can be responsible for actuating forward and backward motion of a tray carriage mechanism within the insulated outer casing (200) of the refrigerated pet food feeder; this can also be part of a horizontal transfer mechanism.

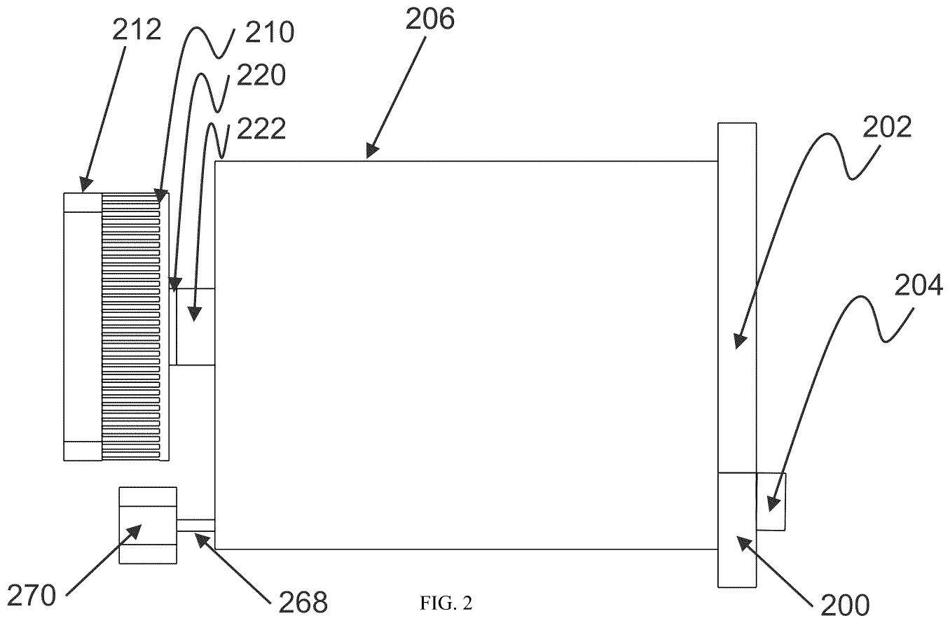

FIG. 2 is a side view of the feeder embodiment of FIG. 1, shown with the insulated outer casing removed to reveal the cooling subsystem and externally mounted mechanical components. This view highlights the thermal coupling between the cooling system and the interior panel, while the internal feeding mechanisms remain hidden from view. FIG. 2 is a side view of the feeder with the insulated casing removed, revealing the thermoelectric cooling system, internal aluminum panel, heat transfer block, and horizontal drive components.

The feeder includes a thermally conductive interior panel (206), which forms the inner surface of the refrigerated chamber and is preferably constructed of aluminum. This panel can be cooled using a thermoelectric cooling system. A thermoelectric cooling element (220) can be positioned with its hot side connected to a rear-mounted heatsink (210), which can be actively cooled by a fan (212). The cold side of the thermoelectric element (220) can be thermally coupled to the interior panel (206) via a heat transfer block (222), which may ensure efficient cooling of the chamber.

Also visible in this view is a horizontal motion motor (270), which can be mechanically connected to a horizontal ball screw (268). The ball screw (268) can drive the tray carriage assembly (not shown) along the horizontal axis for dispensing food. The front access door (202) and feed door (204) can be partially visible from this angle, providing a reference for the feeding path. This view illustrates how the active cooling system interfaces with the chamber wall and how the motorized drive components are mounted around the chamber enclosure.

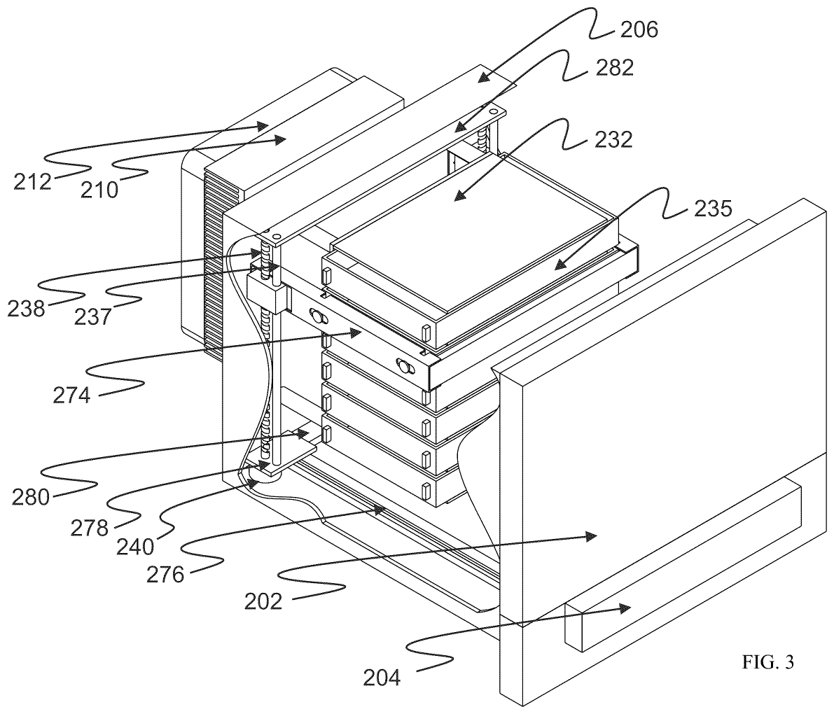

FIG. 3 is a perspective cutaway view of the feeder shown in FIG. 2, with a portion of the thermally conductive interior panel (206) removed to reveal the internal motion components. This view is taken from the top-front-right angle and provides a spatial overview of the mechanisms that transport food trays within the refrigerated chamber. FIG. 3 is a perspective cutaway view of the feeder, showing internal motion systems including stacked trays, tray platforms, dual vertical ball screw assemblies, and the horizontal carriage with spring-loaded dispensing door.

A stack of six removable food trays (235) is shown, each of which can be structured and configured to rest on a rigid tray platform (232). For clarity, only the uppermost tray platform (232) is explicitly illustrated, covering the topmost tray. The remaining platforms, which support the lower trays, can be identical in structure and mounting but are omitted in this view to reduce visual clutter. Each platform (232) can be affixed to the structural frame and positioned between adjacent trays, providing consistent support across the full height of the stack.

Vertical motion can be achieved through two mirrored motion assemblies, one on each side of the tray stack. Each assembly can include a vertical ball screw (238), a ball screw nut, and a vertical linear guide rail (237). A horizontal carriage (278) is shown traveling along a horizontal guide rail (276). This carriage can support one side of the tray gripper arm (274). Although only one carriage is labeled in this view, the system can include a second, symmetric carriage, on the opposite side of the feeder. The left and right carriages can be mechanically linked by a rigid horizontal connector (280), which may ensure synchronized motion. While not visible in this figure, a horizontal ball screw (268), driven by a horizontal motor (270), can engage with this connector to drive the entire gripper arm (274) forward and backward within the device.

An upper crossbar (282) also connects the left and right vertical motion assemblies to improve structural stability during motion. The vertical lift motor (240), which drives the vertical ball screw (238), is visible in this view.

The front access door (202) and dispensing door (204) are both visible. When the carriage arm (274) moves forward to present a selected tray (235), it can push against the spring-loaded dispensing door (204), causing it to open. When the arm retracts, the door (204) may automatically return to the closed position under spring force, helping to seal the chamber without requiring a mechanical linkage.

Remaining thermal system components, such as the heatsink (210) and fan (212), are partially visible on the rear side of the thermally conductive panel (206). The thermoelectric cooling system and heat transfer block (222) were described in FIG. 2 and remain hidden in this view. This figure provides a clear three-dimensional understanding of the internal motion architecture before the more detailed side and frontal cutaway views.

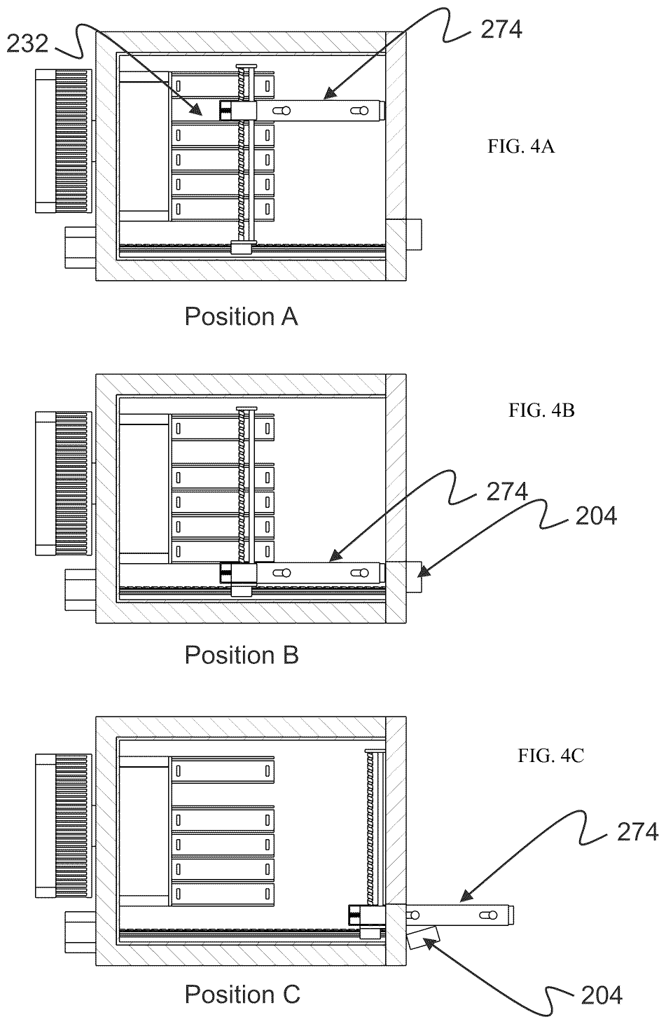

FIG. 4 illustrates three positions of the tray carriage arm (274) during the process of retrieving and dispensing a food tray (235). In this side cutaway view, the tray being carried is not visible, as it is enclosed within the walls of the carriage arm, which can be approximately the same height as the tray itself. FIG. 4 is a side cutaway view showing three positions of the tray carriage arm during retrieval and dispensing of a tray: (A) extraction, (B) alignment, and (C) presentation through the feed door.

Position A: The tray carriage arm (274) can be in an extended position, having engaged with and extracted a selected tray (235) from the second shelf from the top. The tray can now be held inside the arm and clear of the tray stack. The corresponding rigid tray platform (232) appears empty, indicating that the tray has been removed.

Position B: The arm (274), carrying the enclosed tray (235), can be moved downward to align with the dispensing door (204). The vertical motion may be achieved via the dual vertical lift systems described in earlier figures.

Position C: The arm (274) has moved forward to push the tray (235) outward through the dispensing door (204). The spring-loaded door (204), mounted on a horizontal hinge, has been rotated open by the advancing arm and tray. Once the tray is retracted, the spring mechanism can automatically return the door to its closed position to preserve thermal insulation.

These FIGS. 4A-C illustrates the coordinated motion system that can enable the feeder to retrieve, reposition, and present individual trays to the pet, while keeping the tray concealed during motion and maintaining temperature integrity via a self-closing door.

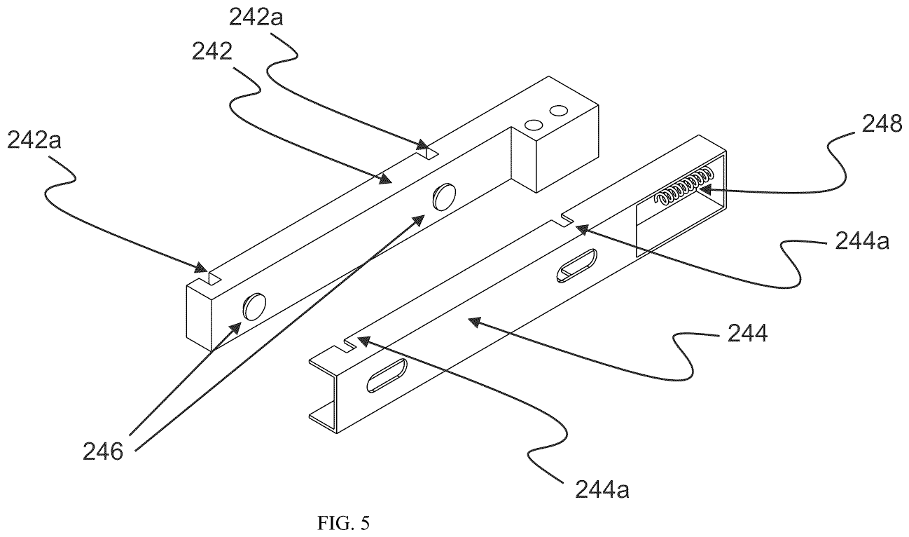

FIG. 5 illustrates the structural composition of the tray gripper arm. The gripper arm can consist of two main components: a tray gripper core (242) and a locking sleeve (244).

The tray gripper core (242) can be a rigid, elongated member with a square cross-section. It includes a set of pin alignment notches (242a) that allow clearance for tray engagement pins (236) when the arm moves vertically. FIG. 5 shows the structure of the tray gripper arm, including the tray gripper core, locking sleeve, notches, compression spring, and its interaction with the rear wall in the home position.

Surrounding the core can be the locking sleeve (244), a U-shaped channel that may wrap around three sides of the core. The sleeve can include its own notches (244a) that correspond in size and shape to those on the core.

The sleeve can be mounted on guide pins (246) that permit limited horizontal motion relative to the core. A compression spring (248) may bias the sleeve forward (toward the tray), such that the notches of the sleeve and core are normally misaligned, locking any inserted tray pin in place.

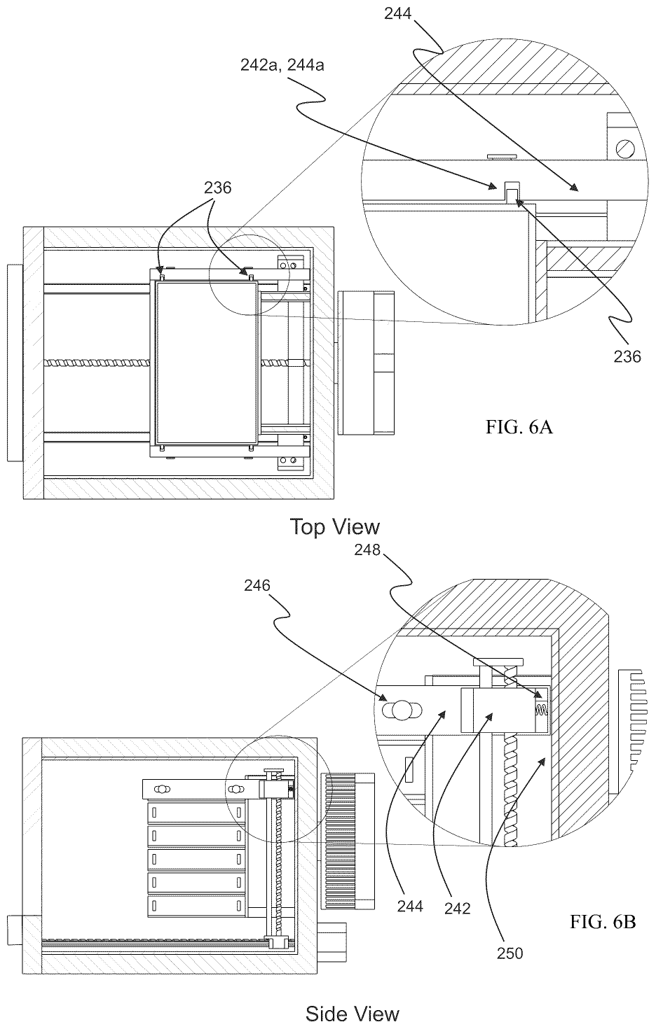

The rear wall (250) of the feeder is positioned such that, when the arm is fully retracted, it presses against the rear of the locking sleeve, compressing the spring and forcing the notches into alignment. This is referred to as the home or unlocked position, and is described in more detail in FIGS. 6A&B.

FIG. 6A provides top and side views of the gripper assembly in the unlocked (home) position, with a detail of the notch alignment allowing vertical movement past tray engagement pins. FIG. 6B shows the side view of the gripper in the unlocked position, with the locking sleeve compressed by the rear wall, maintaining alignment for vertical travel.

FIG. 6A is a top view of the tray gripper assembly in unlocked (home) position, showing the tray gripper assembly in its home position, fully retracted to the rear of the feeder. In this state, the tray engagement pins (236) on both sides of the tray (235) can be aligned with the pin alignment notches (242a) on the tray gripper core (242) (The core itself is not visible in this top view), the locking sleeve (244) is shown in its retracted position, with its own notches (244a) also aligned with those on the core. This alignment can allow the entire gripper arm to move vertically past the tray pins without interference.

In the magnified detail view of FIG. 6A, highlights the interface between the tray pins (236), the core notches (242a), and the sleeve notches (244a). Both sets of notches are shown fully aligned, representing the unlocked configuration, which can permit free vertical movement of the gripper.

FIG. 6B is a side view of a gripper in the home (unlocked) position, which shows the same home position, with the gripper assembly retracted toward the rear wall (250) of the feeder. This view reveals the structural interaction between the core and sleeve, where the tray gripper core (242) can be enclosed by the locking sleeve (244), which can be mounted on guide pins (246) to allow limited horizontal sliding motion. A compression spring (248) can be positioned between the sleeve and internal stops on the guide pins, biasing the sleeve forward. In this position, the rear wall (250) can press against the back of the sleeve, compressing the spring and holding the sleeve in its notch-aligned (retracted) state.

In the magnified detail view of FIG. 6B, the sleeve mechanism shows how the spring can be compressed by the rear wall, allowing the core notches (242a) and sleeve notches (244a) (not visible in this view) to remain aligned. This mechanism may ensure that vertical motion is possible only when the gripper is in its home position, with the sleeve locked into alignment by the physical stop at the back of the feeder.

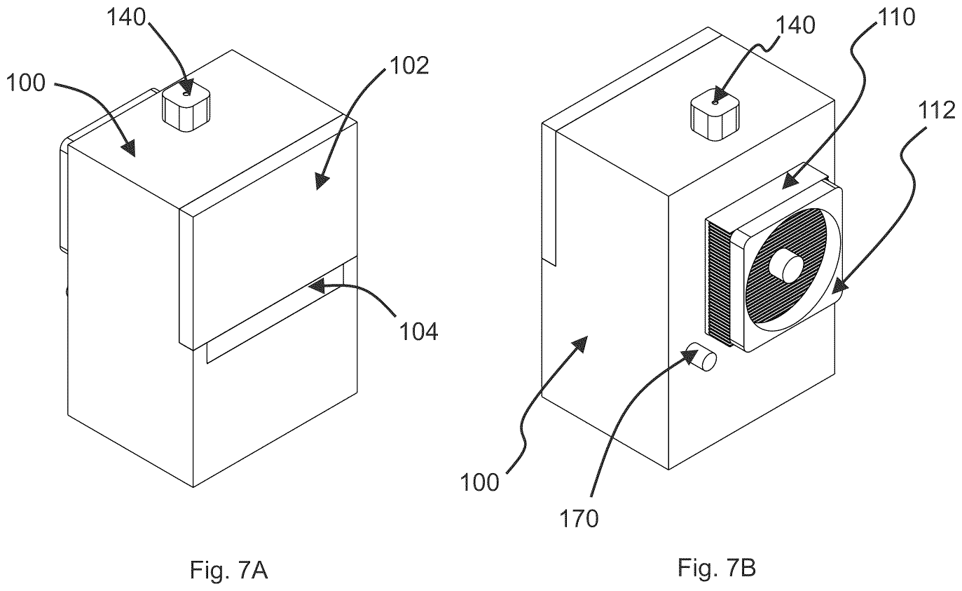

In an alternative embodiment, where the architecture is varied, a moving tray stack with a horizontal retrieval arm can have the following configuration, as illustrated in FIG. 7A. Where FIG. 7A is a perspective view of the front, top, and right side of the alternative embodiment of a vertical refrigerated wet food feeder. The feeder can be enclosed in an insulated outer casing (100), which can include a hinged front access door (102) for loading food trays and a smaller feed door (104) located below the main access door for dispensing food. The access door (102) and feed door (104) can both be insulated to maintain internal temperature. A vertical lift motor (140) can be mounted at the top of the device, and is partially visible and can be used to actuate a vertical ball screw system for adjusting the position of the tray stack.

FIG. 7A is a front-right-top perspective view of a second feeder architecture, showing the insulated enclosure, access doors, vertical lift motor, and general layout. FIG. 7B is a back-left-top perspective view of the same feeder, showing the rear-mounted heatsink, fan, and horizontal drive motor.

Illustrated in FIG. 7B is a perspective view of the back, top, and left side of the feeder of FIG. 7A. The same insulated enclosure (100) and top-mounted vertical lift motor (140) are visible. A horizontal drive motor (170), mounted near the rear of the feeder, is shown and is used to control the horizontal motion of a tray carriage. A heatsink (110) is visible on the rear side of the device, with a heatsink-mounted fan (112) positioned to provide active cooling for the thermal subsystem.

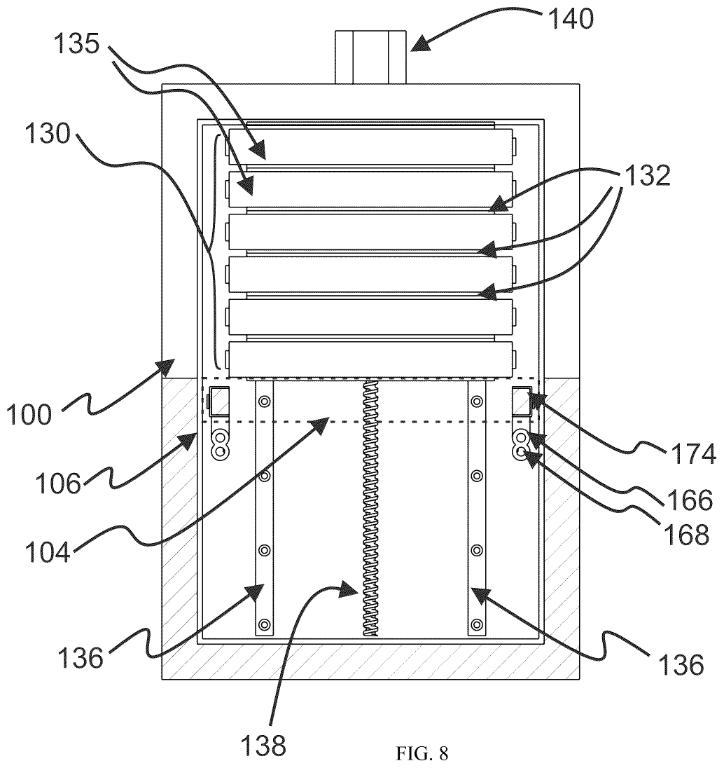

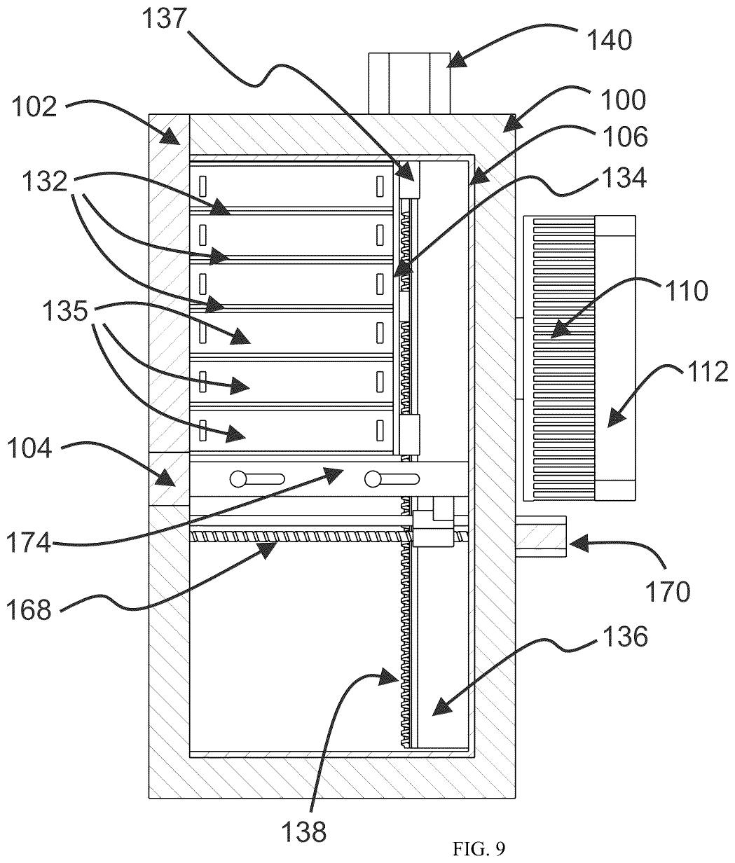

FIG. 8 is a frontal cutaway view of the feeder interior, illustrating the tray stack mounted on a vertically movable panel, central ball screw, horizontal tray carriage arms, and the dispensing path. FIG. 8 is a frontal cutaway view of the pet feeder embodiment of FIG. 7, with the front wall and access door (102) removed to reveal the internal mechanical and thermal components. The feeder can be enclosed in an insulated outer casing (100), and its interior can be lined with a thermally conductive aluminum panel (106), which may form a cooled inner chamber and is in thermal contact with the subsystem described in FIG. 9.

Centrally positioned within the cooled interior formed by the aluminum panel (106) can be a vertical ball screw (138), flanked by two vertical linear guide rails (136). These components may support vertical motion of the tray stack (130), which can include rigid tray platforms (132) mounted on a vertical support panel (134). Each platform may hold a removable food tray (135). A vertical lift motor (140), that can be mounted above the chamber and visible in this view, can drive the ball screw (138) to move the entire tray stack up and down to align a selected tray (135) with the feed opening (104), which is depicted in FIG. 8 as a square outlined in dashed lines.

Positioned on both sides of the tray stack (130) are the horizontal transfer mechanisms. Each includes: a ball screw nut driven along a horizontal ball screw (168), a bushing that slides along a horizontal guide rail (166), and a cross-section of the L-shaped tray carriage arm (174).

FIG. 8 is a frontal cutaway view showing the internal vertical and horizontal motion systems used to align and deliver trays through the dispensing opening (104). The tray stack (130) can be mounted on a vertically movable panel driven by a central ball screw (138), and opposing horizontal tray carriage arms (174) on either side provide lateral motion for dispensing.

For clarity, these components are labeled on only one side in FIG. 8, but an identical mirrored set is positioned on the opposite side of the tray stack. These opposing arms grip the tray from both sides and push it forward through the feed opening (104) for dispensing. When retracted, the arms clear the way for vertical movement of the tray stack.

FIG. 9 is a side cutaway view of the pet feeder of FIG. 7, with the insulated casing (100) and inner aluminum cooling panel (106) partially removed to reveal the internal components of the system. FIG. 9 is a side cutaway view showing the vertical and horizontal motion systems, tray stack, ball screws, guide rails, and the thermoelectric cooling system, including the heatsink and fan.

A motorized lift mechanism can include a vertical lift motor (140) that can be mounted at the top of the enclosure and may drive a vertical ball screw (138), which can be coupled to the rear surface of the vertical support panel (134). Vertical linear guide rails (136) can be positioned in parallel with the ball screw (138), and the vertical support panel (134) can be mounted to carriages (137) on both an upper and lower portions of the guide rails (136), providing stable guided motion. Each vertical guide rail (136) can include at least one carriage (137) that may provide linear bearing support for vertical movement.

A plurality of rigid tray platforms (132) can be affixed to the vertical support panel (134), and removable food trays (135) can be seated on each platform. The tray stack (130) can move vertically within the cooled interior to align a selected tray (135) with the feed opening (104), which is visible in cross-section alongside the larger front access door (102).

Positioned in parallel with the tray stack (130) can be a horizontal transfer mechanism, which may include: a horizontal ball screw (168), its associated drive motor (170), a ball screw nut connected to an L-shaped carriage arm (174), and a parallel horizontal guide shaft for lateral support and guidance

The rear portion of the device houses the thermal management subsystem, which may include: a heatsink (110) that can be mounted to the hot side of a thermoelectric cooler (not visible in this view), and a fan (112) that may be positioned to provide airflow across the heatsink for active heat dissipation. The cold side of the thermoelectric cooler can be thermally coupled to the aluminum cooling panel (106) via a thermal transfer block (also not visible), allowing heat to be extracted from the internal chamber.

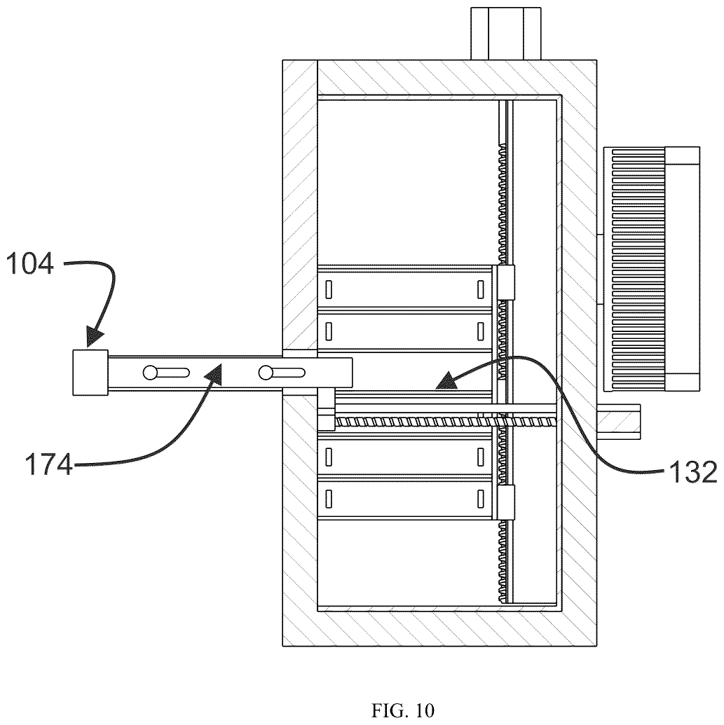

FIG. 10 is a side cutaway view of the pet feeder of FIG. 9, illustrating the system in a dispensing position. A selected food tray (135) has been moved forward by the horizontal tray carriage arm (174), which is now fully extended. The tray (135) can be positioned outside the cooled interior of the device, accessible to the pet. FIG. 10 shows the same side cutaway view in a dispensing state, with the tray carriage arm extended and the tray presented outside the cooled chamber through the open feed door.

In this position, the corresponding tray platform (132) in the tray stack (130) can be empty, indicating the tray has been removed for dispensing. The insulated feed door (104), which can be mechanically linked to the front of the tray carriage arm (174), has also moved forward and is shown in an open position. When the arm (174) retracts, it can pull the feed door (104) back with it, thereby closing the opening to the cooling chamber. This mechanism may ensure the feed door (104) remains closed when food is not being actively dispensed, helping to maintain thermal efficiency.

All other structural and mechanical components can remain consistent with those described in FIG. 9, including: an insulated enclosure (100), an aluminum cooling panel (106), a vertical support panel (134), linear guide rails (136), a vertical drive motor (140), a vertical ball screw (138), a horizontal drive motor (170), and/or a thermal management subsystem with heatsink (110) and fan (112).

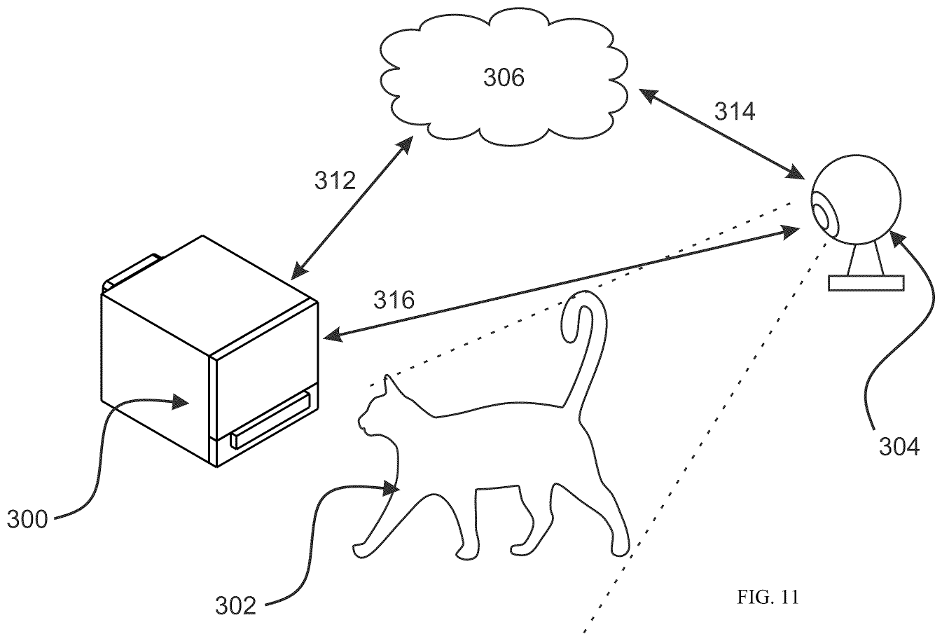

FIG. 11 illustrates an embodiment of a refrigerated pet food feeding system (300), similar to the embodiments 100 and 200, and is configured to operate with a remote camera (304). The Remote camera (304) can be positioned separately from the feeder (300) and oriented to capture an approaching pet (302), shown within the camera's field of view (dashed lines). The remote camera (304) can be configured to visually identify the pet (302) and, upon identification, transmit an authorization signal to the feeder's controller. This embodiment can support multiple communication pathways. For example, a first pathway where direct communication (316) can be between the camera system (304) and the feeder (300) to allow the camera to perform local pet identification and wirelessly transmit an authorization signal directly to the feeder system (300).

A second pathway, where direct communication (314) can be between the camera (304) and a cloud system (306) to allow the camera (304) to send visual data to the cloud (306), where in the cloud (306), the remote pet identification can be performed. Once the pet is recognized, the cloud (306) can send an authorization signal to the feeder system (300). A second pathway, where direct communication (312) can be between the cloud system (306) and the feeder (300) to enable transmission of authorization data, feeding instructions, firmware updates, and synchronization of feeding profiles.

The controller (similar to feeders 100 & 200) within the feeder (300) can be configured to receive an authorization signal from either the camera (304) or the cloud system (306). Upon validation, the controller can associate the identified pet (302) with a unique feeding profile and can then actuate a motorized mechanism (similar to feeders 100 & 200) to move a selected tray to a dispensing position. This figure demonstrates both local and cloud-based pet identification options, as well as the feeder's flexibility in communicating with external devices through multiple, redundant communication paths.

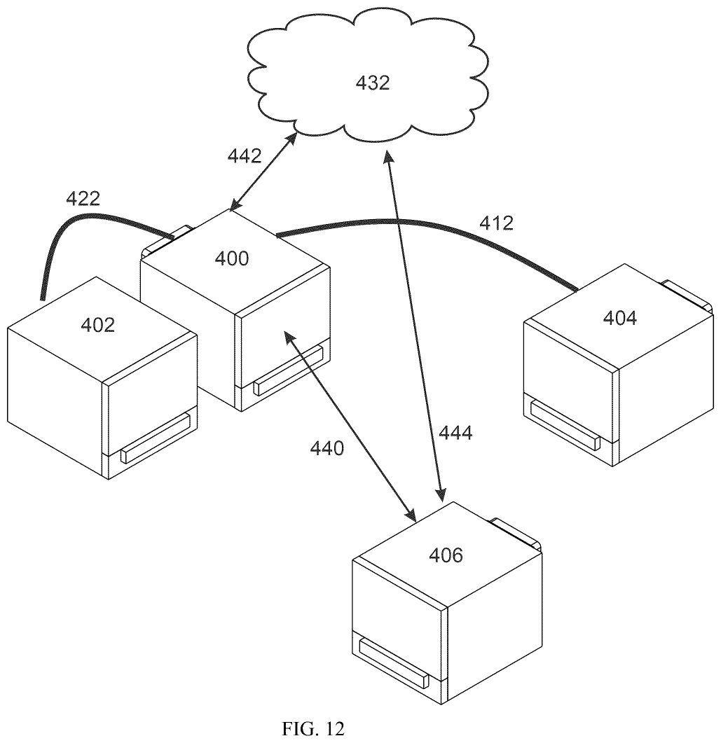

FIG. 12 illustrates a networked multi-unit embodiment of the refrigerated pet food feeding system. A primary unit, coordinator system feeder 400, can operate as a networked system coordinator. Additional feeders 402, 404, and 406 demonstrate a range of connectivity and resource-sharing configurations supported by the system in FIG. 12. Feeder 402 can be connected to coordinator system feeder 400 via line 422, which may carry both electrical power and a thermal transfer medium. This can enable feeder 402 to share power and benefit from distributed cooling with coordinator system feeder 400, for example, through circulation of water, alcohol, or other antifreeze liquids between cooling systems. Feeder 404 can be connected to the coordinator system feeder 400 via line 412, which can supply electrical power only. Feeder 404 can manage its own internal cooling system, but receives power from the coordinator system feeder 400. Feeder 406 is shown with no physical connection to the coordinator system feeder 400. It can be fully self-powered and self-cooled, but remains connected logically within the coordinator system feeder 400. Feeder 406 can receive control signals or scheduling data in two ways: directly from coordinator system feeder 400 via communication link 440, Indirectly through the cloud system 432 shown via communication link 444, coordinator system feeder 400 may also communicate with cloud system 432 through a bidirectional communication path labeled 442, enabling features such as: cloud-based user control, firmware updates, remote scheduling, cross-device pet profile synchronization, Multi-device coordination logic.

The system 400 in FIG. 12 can illustrate various feeders in the system may be linked by physical, wireless, or cloud-based communication, and may optionally share power and/or cooling resources, depending on deployment needs.

While embodiments of the disclosed improvements have been illustrated and described, it will also be apparent that various modifications can be made without departing from the scope of the invention. It is also contemplated that various combinations or sub-combinations of the specific features and aspects of the disclosed embodiments can be combined with, or substituted for, one another in order to form varying modes of the embodiments. Accordingly, it is not intended that the disclosed improvements be limited, except as by the appended claims. Any references cited within are herein incorporated by reference in their entirety.

What is claimed:

1. A refrigerated food feeding system comprising:
a refrigeration system;
an insulated enclosure having a front-loading access door and a dispensing port disposed thereon, wherein a dispensing door is disposed on the dispensing port;
a plurality of food trays arranged vertically within the insulated enclosure, wherein each food tray is structured and configured to store a portion of food;
a motorized lift mechanism is structured and configured to align a selected tray of the plurality of food trays with the dispensing port;
a horizontal transfer mechanism is structured and configured to move the selected tray within the insulated enclosure to a dispensing position outside the insulated enclosure via the dispensing port, and to retract the selected tray after a predetermined period, wherein the dispensing door is configured to open and close in coordination with the movement of the selected tray; and
a controller configured to operate the motorized lift mechanism, the lateral transfer mechanism, and the door in accordance with a programmed feeding schedule.

2. The refrigerated food feeding system of claim 1, wherein the motorized lift mechanism is at least one of a vertical lift motor, at least one belt drive, or a vertical ball screw.

3. The refrigerated food feeding system of claim 2, wherein the motorized lift mechanism further comprises a motorized shuttle to retrieve and deliver the selected tray.

4. The refrigerated food feeding system of claim 1, wherein the horizontal transfer mechanism comprises a horizontal ball screw, a horizontal motion motor, a horizontal guide rail, and a horizontal carriage.

5. The refrigerated food feeding system of claim 1, wherein a heating element is positioned beneath the selected tray in the dispensing position outside the insulated enclosure.

6. The refrigerated food feeding system of claim 1, wherein after the predetermined time, the controller is configured to deliver a previously selected tray, wherein the previously selected tray contains an unconsumed portion of food, for a second predetermined period to the dispensing position outside the insulated enclosure via the dispensing port.

7. The refrigerated food feeding system of claim 1 further comprising a remote camera system configured to visually identify a pet and upon identification of the pet to wirelessly communicate an authorization signal to the controller to move the selected tray to the dispensing position.

8. The refrigerated food feeding system of claim 7, wherein the camera system is cloud-connected and performs pet identification remotely before communicating the authorization signal.

9. The refrigerated food feeding system of claim 7, wherein the remote camera system is mounted separately from the feeding system and positioned to capture the approaching pet from an alternate angle.

10. The refrigerated food feeding system of claim 7, wherein the controller is configured to associate the identified pet with a unique feeding profile.

11. The refrigerated food feeding system of claim 1, wherein at least one additional refrigerated food feeding system is linked via a network to the refrigerated food feeding system.

12. The refrigerated food feeding system of claim 1, wherein a food presence sensor is configured to detect remaining food in the dispensed tray after the predetermined time.

13. The refrigerated food feeding system of claim 12, wherein the controller is configured to track the amount of remaining food, and further wherein the controller will communicate to a user device the presence of the remaining food.

14. A networked multi-unit refrigerated food feeding system comprising:
a coordinator system feeder comprising:
a refrigeration system;
an insulated enclosure having a front-loading access door and a dispensing port disposed thereon, wherein a dispensing door is disposed on the dispensing port;
a plurality of food trays arranged vertically within the insulated enclosure, wherein each food tray is structured and configured to store a portion of food;
a motorized lift mechanism is structured and configured to align a selected tray of the plurality of food trays with the dispensing port;
a horizontal transfer mechanism is structured and configured to move the selected tray within the insulated enclosure to a dispensing position outside the insulated enclosure via the dispensing port, and to retract the selected tray after a predetermined period, wherein the dispensing door is configured to open and close in coordination with the movement of the selected tray; and
a controller configured to operate the motorized lift mechanism, the lateral transfer mechanism, and the door in accordance with a programmed feeding schedule;
at least one subordinate food feeding system linked to the coordinator system feeder, wherein the at least one subordinate food feeding receives at least one of a control signal or scheduling data, wherein the at least one subordinate food feeding system comprises:
an insulated enclosure having a front-loading access door and a dispensing port disposed thereon, wherein a dispensing door is disposed on the dispensing port;
a plurality of food trays arranged vertically within the insulated enclosure, wherein each food tray is structured and configured to store a portion of food;
a motorized lift mechanism is structured and configured to align a selected tray of the plurality of food trays with the dispensing port;
a horizontal transfer mechanism is structured and configured to move the selected tray within the insulated enclosure to a dispensing position outside the insulated enclosure via the dispensing port, and to retract the selected tray after a predetermined period, wherein the dispensing door is configured to open and close in coordination with the movement of the selected tray; and
a controller configured to operate the motorized lift mechanism, the lateral transfer mechanism, and the door in accordance with a programmed feeding schedule.

15. The refrigerated food feeding system of claim 14, wherein the motorized lift mechanism is at least one of a vertical lift motor, at least one belt drive, or a vertical ball screw.

16. The refrigerated food feeding system of claim 15, wherein the motorized lift mechanism further comprises a motorized shuttle to retrieve and deliver the selected tray.

17. The refrigerated food feeding system of claim 14, wherein the horizontal transfer mechanism comprises a horizontal ball screw, a horizontal motion motor, a horizontal guide rail, and a horizontal carriage.

18. The refrigerated food feeding system of claim 14, wherein a heating element is positioned beneath the selected tray in the dispensing position outside the insulated enclosure.

19. The refrigerated food feeding system of claim 14 further comprising a remote camera system configured to visually identify a pet and upon identification of the pet to wirelessly communicate an authorization signal to the controller to move the selected tray to the dispensing position.

20. The refrigerated food feeding system of claim 19, wherein the camera system is cloud-connected and performs pet identification remotely before communicating the authorization signal.
